(19) United States
(12) Patent Application Publication
(10) Pub. No.: US 2003/0190466 A1
(43) Pub. Date: Oct. 9, 2003

(54) Adhesive sheet for producing semiconductor devices

(76) Inventors: Katsuji Nakaba, Shizuoka-shi (JP); Toshihiro Nakajima, Shizuoka-shi (JP); Takeshi Sato, Shizuoka-shi (JP); Osamu Oka, Yaizu-shi (JP)

Correspondence Address: NIXON & VANDERHYE, PC, 1100 N GLEBE ROAD, 8TH FLOOR, ARLINGTON, VA, 22201-4714, US

(21) Appl. No.: 10/404,121

(22) Filed: Apr. 2, 2003

(30) Foreign Application Priority Data
Apr. 3, 2002 (JP) P2002-101703
May 16, 2002 (JP) P2002-142056

(51) Int. Cl. B32B 7/12; B32B 15/04

(52) U.S. Cl. 428/344; 428/343

(57) ABSTRACT

An adhesive sheet for producing semiconductor devices, such as QFNs, can prevent the generation both of wire-bonding defects and mold flashes, and can thereby prevent the production of defective semiconductor devices. The present invention provides an adhesive sheet for producing semiconductor devices which is detachably attached to a lead frame and which comprises a heat resistant substrate and an adhesive layer which is arranged on one surface of the heat resistant substrate, wherein the adhesive layer contains, a thermosetting resin component (a) and a thermoplastic resin component (b); and the weight ratio of the component (a)/the component (b) is 0.3 to 3.

### BACKGROUND OF THE INVENTION

1. Field of the Invention

The present invention relates to an adhesive sheet which is detachably attached to a lead frame and which is used for producing semiconductor devices, such as quad flat non-leaded type semiconductor packages.

2. Description of the Related Art

Recently, with the reduction in size of electronics, such as portable personal computers and portable telephones, and increasing functions thereof, it has been desired to reduce the size of electronic elements comprising electrorics, so as to allow integration in high density. That is, a technique for mounting electronic elements in high density has been required. In light of the above, instead of a peripheral-mounting type semiconductor device in which external terminals are mounted at a peripheral area of a semiconductor device, such as a QFP (Quad Flat Package) and a SOP (Small Out Line Package), a surface-mounting type semiconductor device in which external terminals are mounted at a surface of a semiconductor device in high density, such as a CSP (Chip Scale Package) has received much attention. In particular, among CSPs, since QFNs (Quad Flat Non-leaded Package) can be manufactured by conventional techniques, this is suitable. Therefore, a QFN has been used as a low number terminal type semiconductor device comprising generally 100 pins or fewer.

The following method has been carried out as a method for manufacturing QFN. At first, in an adhesive sheet attaching step, an adhesive sheet is attached on one surface of a lead frame. Then, in a die attaching step, at a plurality of semiconductor element mount parts (die pad parts), which are formed at the lead frame, semiconductor elements, such as IC chips, are mounted. In a wire-bonding step, a plurality of leads, which are arranged around the semiconductor element mount parts of the lead frame, and the semiconductor elements are electrically connected with bonding wires. Next, in a resin filling step, the semiconductor elements are filled with a filler resin. After this step, in an adhesive sheet peeling step, a QFN unit, in which a plurality of QFNs are arranged, is prepared by peeling the adhesive sheet from the lead frame. In a dicing step, which is the last step, a plurality of QFNs are prepared simultaneously by dicing the prepared QFN unit along the outer surface of the QFNs.

In this method for manufacturing a QFN, as a conventional adhesive sheet for attaching a lead frame, an adhesive sheet comprising a substrate, which is a heat resistant film, and an adhesive layer, which contains silicone adhesive compounds and is formed at one surface of the substrate, has been widely used.

However, when this conventional adhesive sheet is used, in the wire-bonding step, there is a case in which a connection defect between the bonding wire and the lead is generated. Below, a connection defect between a bonding wire and a lead is denoted by “a wire-bonding defect”. In addition, there are cases in which a phenomenon called “mold flash” occurs. The mold flash occurs, when in the resin filling step, adhesive strength of the adhesive sheet decreases, the lead frame peels partially from the adhesive sheet, the filler resin flows between the lead frame and the adhesive sheet, and thereby the filler resin attaches at external connection parts of the lead (the surface of the lead at which the adhesive sheet is attached). When a produced semiconductor device, in which the mold flash is generated, is mounted on a distributing board, because the filler resin attaches at the external connection parts of the lead, there is a possibility that connection defects are generated.

### SUMMARY OF THE INVENTION

In consideration of the above described problems with conventional technology, an object of the present invention is to provide an adhesive sheet for producing semiconductor devices, such as QFNs, which can prevent the generation both of wire-bonding defects and mold flashes, and can thereby prevent the production of defective semiconductor devices.

In order to achieve the object, the present invention provides an adhesive sheet for producing semiconductor device which is detachably attached to a lead frame and which comprises a heat resistant substrate and an adhesive layer which is arranged on one surface of the heat resistant substrate, wherein the adhesive layer contains a thermosetting resin component (a) and a thermoplastic resin component (b); and the weight ratio of the component (a)/the component (b) is 0.3 to 3.

The adhesive sheet has suitable elasticity and high adhesive strength when the adhesive layer is subjected to high temperatures. Therefore, the adhesive sheet of the present invention can prevent the generation of wire-bonding defects, mold flashes, and adhesive transfers, and this can thereby prevent the production of defective semiconductor devices.

In the adhesive sheet, it is preferable for the heat resistant substrate to be a heat resistant film, and for the glass transition temperature and the coefficient of thermal expansion of the heat resistant film to be 150° C. or greater and 5 to 50 ppm/° C.

In the adhesive sheet, it is preferable for the heat resistant substrate to be a metal foil and for the coefficient of thermal expansion of the metal foil to be 5 to 50 ppm/° C.

In the adhesive sheet, it is preferable for the metal foil to be an electrolytic metal foil having a rough surface and for the adhesive layer to be attached on the rough surface of the electrolytic metal foil.

In the adhesive sheet, it is preferable for the thermosetting resin component (a) to be at least one resin of epoxy resins and phenol resins.

In the adhesive sheet, it is preferable for the thermoplastic resin component (b) to be a polymer having an amide bond.

In the adhesive sheet, it is also preferable for the thermoplastic resin component (b) to be a butadiene containing resin.

In the adhesive sheet, it is preferable for the weight average molecular weight of the thermoplastic resin component (b) to be 2,000 to 1,000,000.

In the adhesive sheet, it is preferable for the storage elastic modulus at 150 to 250° C. after hardening of the adhesive layer to be 5 MPa or more.

In addition in the adhesive sheet, it is also preferable for a protective film to be arranged on the adhesive layer.

### BRIEF DESCRIPTION OF THE DRAWINGS

FIG. 1 is a plane view showing a lead frame which are suitably used for producing QFNs using the adhesive sheet of the present invention.

FIGS. 2A to 2F show steps for producing QFNs using the adhesive sheet of the present invention.

### DETAILED DESCRIPTION OF THE PREFERRED EMBODIMENTS

Below, the adhesive sheet for producing semiconductor devices of the present invention will be explained in detailed.

The adhesive sheet of the present invention comprises a heat resistant substrate and an adhesive layer which is arranged on one surface of the heat resistant substrate and which contains a thermosetting resin component (a) and a thermoplastic resin component (b).

As the heat resistant substrate, a heat resistant film, a metal foil, and the like can be used.

When semiconductor devices, such as QFNs are produced using the adhesive sheet of the present invention, the adhesive sheet is subjected to high temperatures such as 150 to 250° C., in a die attaching step, a wire-bonding step, and resin filling step. When a heat resistant film is used for the heat resistant substrate and the heat resistant film is heated to the glass transition temperature (Tg) thereof or greater, the coefficient of thermal expansion of the heat resistant film increases suddenly. Thereby, the volume difference between the metal lead frame and the heat resistant film increases. As a result, when the lead frame and the heat resistant film are cooled to room temperature, there is a possibility that warps are caused in the lead frame and the heat resistant film. When warps are generated in the lead frame and the heat resistant film, in the resin filling step, it is impossible to mount the lead frame on positioning pins comprising a die, and there is a possibility that dislocation will occur.

Therefore, when a heat resistant film is used for the heat resistant substrate, the glass transition temperature of the heat resistant film is preferably 150° C. or greater, more preferably 180° C. or greater. In addition, the coefficient of thermal expansion at 150 to 250° C. of the heat resistant film is preferably 5 to 50 ppm/° C., and more preferably 10 to 30 ppm/° C. The heat resistant film includes, for example, films made of polyimides, polyamides, polyether sulfones, polyphenylene sulfides, polyether ketones, polyether ether ketones, triacetylcelluloses, and polyetherimides.

Moreover, when a metal foil is used for the heat resistant substrate, for the same reasons, the coefficient of thermal expansion at 150 to 250° C. of the metal foil is preferably 5 to 50 ppm/° C., and more preferably 10 to 30 ppm/° C. The metal foil includes, for example, foils made of gold, silver, copper, platinum, aluminum, magnesium, titanium, chromium, manganese, iron, cobalt, nickel zinc, palladium, cadmium, indium, and tin; foils containing alloys thereof as a main component, and foils plated thereby.

In order to prevent the occurrence of adhesive transfers in the adhesive sheet peeling step, when Sa is an adhesive strength between the beat resistant substrate and the adhesive layer and Sb is an adhesive strength between the filler resin and the lead frame and the adhesive layer, a ratio of an adhesive strength ratio, Sa/Sb is preferably 1.5 or more. When Sa/Sb is less than 1.5, adhesive transfers are easily generated in the adhesive sheet peeling step. In order to make the adhesive strength ratio, Sa/Sb 1.5 or more, when the heat resistant film is used for the heat resistant substrate, before forming the adhesive layer, it is preferable for a surface of the heat resistant film, at which the adhesive layer is formed, to be treated such that the adhesive strength Sa between the heat resistant film and the adhesive layer is increased, such as a corona treatment, a plasma treatment, and a primer treatment. Moreover, metal foils are classified into rolled metal foils and electrolytic metal foils. In order to make the adhesive strength ratio Sa/Sb 1.5 or more, it is preferable to use an electrolytic metal foil, and to form the adhesive layer on a rough surface of the electrolytic metal foil. Among the electrolytic metal foils, electrolytic copper foil is most preferable.

The adhesive layer contains a thermosetting resin component (a) and a thermoplastic resin component (b). The weight ratio between the component (a) and the component (b) must be 0.3 to 3. The weight ratio is preferably 0.7 to 2.3. When the weight ratio is less than 0.3, the storage elastic modulus of the adhesive layer remarkably decreases. In the wire-bonding step, the connection defect between the bonding wire and the lead is caused. In contrast, the weight ratio exceeds 3, flexibility of the adhesive layer degraded. In the resin filling step, the adhesive strength of the adhesive sheet decreases, the lead frame peels partially from the adhesive sheet, and mold flashes are formed, and an adhesive transfers occur.

In the resin filling step for producing a semiconductor package, while a semiconductor element is heated at 150 to 200° C., the semiconductor element is packed with a filler resin by applying pressure of 5 to 10G Pa. When the adhesive layer of the adhesive sheet is subjected to a high temperature, the adhesive strength of the adhesive layer, specifically, the adhesive strength between the adhesive layer and the lead frame, decreases. Therefore, the adhesive layer peels partially from the lead frame due to the pressure of the filler resin. Then, a mold flash sometimes is formed. However, in the adhesive sheet of the present invention, which comprises the adhesive layer containing a thermosetting resin component (a) and a thermoplastic resin component (b), the adhesive strength of the adhesive layer does not decrease. Therefore, the above problems do not occur in the adhesive sheet of the present invention.

The thermosetting resin component (a) includes, for example, urea resins, melamine resins, benzoguanamine resins, acetoguanamine resins, phenol resins, resorcinol resins, xylene resins, furan resins, unsaturated polyester resins, diallylic phtalate resins, isocyanate resins, epoxy resins, maleimide resins, and nadimide resins. These thermosetting resins can be used alone or in combinations of two or more. Among these thermosetting resins, when at least one of epoxy resins and phenol resin is contained as the component (a), the adhesive layer has a high elastic modulus at a treatment temperature in the wire-bonding step, and an excellent adhesive strength to the lead frame at a treatment temperature in the resin filling step.

The thermoplastic resin component (b) includes, for example, acrylonitrile-butadiene copolymers (NBR), acrylonitrile-butadiene-styrene resins (ABS), styrene-butadiene-ethylene resins (SEBS), styrene-butadiene-styrene resins (SBS), polyacrylonitriles, polyvinyl butyrals, polyamides, polyamideimides, polyimides, polyesters, polyurethanes, and polydimethylsiloxanes. Among these thermoplastic resins, polyamides and polyamideimides, which is one of polymer having an amide bond, are preferable, because they have improved heat resistance and adhesiveness. These thermoplastic resins can be used alone or in combinations of two or more.

In addition, among these thermoplastic resins, butadiene containing resins (b) are more preferable. Butadiene containing resins (b) are resins which contain butadiene as monomer unit and which have elasticity. The content of butadiene in butadiene containing resin (b) is preferably 10% by weight or more. Resin containing butadiene (b), which contains butadiene of 10% by weight or more, applies high elasticity to the adhesive layer, and improves cohesion of the adhesive layer. Thereby, the adhesive transfers in the adhesive sheet peeling step can be prevented. Resin containing butadiene (b) includes, for example, acrylonitrile-butadiene coplymers (NBR), styrene-butadiene-ethylene copolymers (SEBS), styrene-butadiene-styrene copolymers (SBS), and polybutadienes. These resins containing butadiene can be used alone or in combinations of two or more. When butadiene containing resin reacts the thermosetting resin component (a), and improves adhesive strength of the adhesive layer. Therefore, resin containing butadiene preferably has at least one group of an amino group, an isocyanate group, a glycidyl group, a carboxyl group containing anhydride thereof, a silanol group, a hydroxyl group, a vinyl group, a methylol group, and a mercapto group. In particular, it is preferable for butadiene containing resin to be at least one of acrylonitrile-butadiene copolymers, acrylonitrile-butadiene-methacylate copolymers, styrene epoxide-butadiene-styrene copolymers, polybutadiene epoxides, because this has improved heat resistance and adhesiveness.

The weight average molecular weight of the thermoplastic resin component (b) is preferably 2,000 to 1,000,000, more preferably 5,000 to 800,000, and most preferably 10,000 to 500,000. The thermoplastic resin component (b) having such weight average molecular weight improves cohesion of the adhesive layer, and this can thereby prevent the generation of adhesive transfers in the adhesive sheet peeling step.

In order to adjust the coefficient of thermal expansion, thermal conductivity, surface tack, adhesiveness, and the like of the adhesive layer, it is preferable to add inorganic or organic fillers in the adhesive layer. The inorganic filler includes, for example, crush type silica, melt type silica, alumina, titanium oxides, beryllium oxide, magnesium oxide, calcium carbonate, titanium nitrides, silicon nitride, boron nitrides, titanium borides, tungsten borides, silicon carbides, titanium carbides, zirconium carbide, molybdenum carbides, mica, zinc oxides, carbon black, aluminum hydroxide, calcium hydroxide, magnesium hydroxide, and antimony trioxide; and fillers, which are made thereof and which have a surface having trimethylsiloxane group and the like. The organic filler includes, for example, fillers made of polyimides, polyamideimides, polyether etherketones, polyetherimides, polyesterimides, nylon, and silicone resins.

As a method for forming the adhesive layer on one surface of the heat resistant substrate, for example, a casting method in which an adhesive is coated directly on the heat resistant substrate and the adhesive is dried, and a lamination method in which an adhesive is coated once on a release film, the adhesive is dried and then the adhesive is transferred to the heat resistant substrate, are preferable.

In addition, organic solvents are preferably used together with the thermosetting resin component (a) and the thermoplastic resin component (b). The organic solvent includes, for example, aromatic solvents such as toluene, xylene, and chlorobenzene, ketone solvents such as acetone, methylethylketone, and methylisobutylketone; aprotic polar solvents such as dimethyl formamide, and N-methyl pyrolidone; and tetrahydrofuran. These organic solvents can be used alone or in combinations of two or more. When the organic solvent is used, it is preferable to solve 1% by weight or greater, preferably 5% by weight or greater of the mixture containing the thermosetting resin component (a) and the thermoplastic resin component (b) in 100% by weight of the solvent, and obtain an adhesive coating.

In the adhesive sheet of the present invention, a release protective film may be attached on the adhesive layer of the adhesive sheet, and the protective film may be released from the adhesive layer just before production of the semiconductor devices. In this case, from the time the adhesive sheet is produced to the time it is used, the adhesive layer is protected from damage. As the protective film, any film having releasability can be used. The protective film includes, for example, films made of polyesters, polyethylenes, polypropylenes, and polyethlene terephthalates; and films which are made of these polymers and of which the surface is treated with silicone resins or fluorine compounds so as to be able to release the film from the adhesive layer.

The storage elastic modulus at 150 to 250° C. after hardening of the adhesive layer is preferably 5 MPa or more, more preferably 10 MPa or more, and most preferably 50 MPa or more. In the specification, “adhesive layer after hardening” means the adhesive layer which is heated in the die attaching step. The measuring conditions of the storage elastic modulus will be explained in the following. In the wire-bonding step for producing the semiconductor devices, while the semiconductor elements and the lead frame are connected using bonding wires, the two ends of the bonding wires are heated to 150 to 250° C. and melted by applying ultrasonic waves of 60 to 120 kHz. During this step, the adhesive layer of the adhesive sheet, which is positioned directly below the lead frame, is subjected to a high temperature, and the elasticity of the adhesive layer is degraded. Thereby, the adhesive layer easily absorbs the ultrasonic waves. As this result, the lead frame easily vibrates and wire-bonding defects are easily generated. However, in the adhesive sheet of the present invention, which comprises the adhesive layer having an improved storage elastic modulus, this problem is hardly generated.

In addition, since mold flashes can be prevented, it is preferable for the adhesive strength at 150 to 250° C. between the adhesive layer and the lead frame to be 10 g/cm or greater.

Production Method for Semiconductor Devices

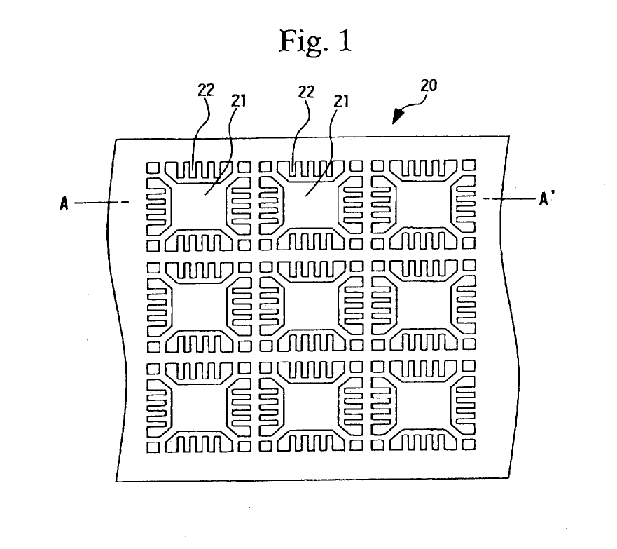

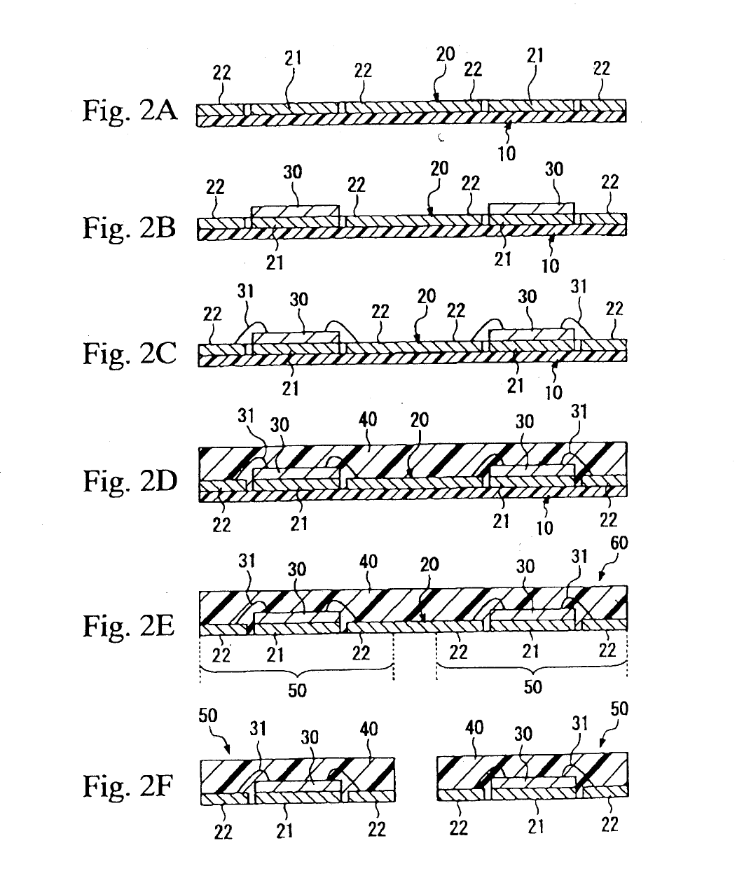

Next, one production method for semiconductor devices using the adhesive sheet of the present invention will be explained referring to FIGS. 1 and 2.

Below, as the semiconductor device, the QFN is exemplified. FIG. 1 is a plane view showing the lead frame viewed from the side at which the semiconductor elements are mounted. FIGS. 2A to 2F show steps for producing QFNs using the lead frame shown in FIG. 1, and this is an enlarged cross-sectional view along line A-A of FIG. 1.

In order to produce a QFN, the lead frame 20 is prepared. The lead frame 20 comprises a plurality of semiconductor element mount parts (die pad parts) 21 and a plurality of leads 22 which are arranged around the semiconductor element mount parts 21. Next, as shown in FIG. 2A, in an adhesive sheet attaching step, the adhesive sheet 10 of the present invention is attached on one surface of the lead frame 20 such that the adhesive layer (not shown in the figures) of the adhesive sheet 10 is attached to the lead frame 20. Moreover, a laminate method is suitable for attaching the adhesive sheet 10 on the lead frame 20. Then, as shown in FIG. 2B, in a die attaching step, the semiconductor elements 30, such as IC chips, are mounted on the semiconductor element mount parts 21 of the lead frame 20 using a die attaching agent (not show in the figures) As shown in FIG. 2C, in a wire-bonding step, the semiconductor elements 30 and the leads 22 of the lead frame 20 are electrically connected with bonding wires 31, such as metal wires. Next, as shown in FIG. 2D, in a resin filling step, the product which is prepared by the previous steps and is shown in FIG. 2C, is put into a die, and this is transfer-molded using a filler resin (mold agent) 40, and the semiconductor elements 30 are filled with the filler resin 40.

After that, as shown in FIG. 2E, in an adhesive sheet peeling step, a QFN unit 60, in which a plurality of QFNs 50 are arranged, is prepared by peeling the adhesive sheet 10 from the filler resin 40 and the lead frame 20. In a dicing step, which is the last step, as shown in FIG. 2F, a plurality of QFNs 50 are prepared simultaneously by dicing the prepared QFN unit 60 along the outer surface of the QFNs 50.

The generation of wire-bonding defects, mold flashes, and adhesive transfers in the QFNs can be prevented by the adhesive sheet 10 of the present invention. Thereby, the adhesive sheet 10 of the present invention can prevent the production of defective semiconductor devices.

Below, the adhesive sheet of the present invention will be explained in detailed referring to Examples and Comparative Examples.

As shown below, the adhesive sheets were prepared in Examples and Comparative Examples, and the obtained adhesives and adhesives sheet were evaluated.

### Example 1

The adhesive coating having the following composition of this Example was prepared.

Next, as the heat resistant base, a polyimide resin film (marketed by Du Pont-Toray Co., Ltd.; trade name: KAPTON® 100EN; thickness: 25 μm; glass transition temperature: 300° C. or greater, coefficient of thermal expansion: 16 ppm/° C.) was used. On the polyimide resin film, the obtained adhesive coating was applied such that the thickness after drying was 6 μm, and this was dried at 100° C. for 5 minutes, and thereby the adhesive sheet of this Example was obtained. Moreover, the weight ratio of the thermosetting resin component (a)/the thermoplastic resin component (b) was 1.48.

| | | |
|---|---|---|
| The thermosetting resin component (a): | | |
| Epoxy resin (marketed by Japan Epoxy Resins Co., | 30 | parts by weight |
| Ltd.; trade name: EPIKOTE ® | | |
| 828; epoxy equivalent: 190) | | |
| Phenol resin (marketed by SHOWA | 29 | parts by weight |
| HIGHPOLYMER; trade name: CKM-2400) | | |
| The thermoplastic resin component (b) | | |
| Dimer acid-based polyamide | 40 | parts by weight |
| (weight average molecular weight: 12,000) | | |
| Other component | | |
| Hardening accelerator (marketed by Shikoku Corp.; | 1 | part by weight |
| 2-ethyl-4-methylimidazole) | | |

### Example 2

The adhesive coating having the following composition of this Example was prepared.

Then, the adhesive sheet of this Example was prepared in a manner identical to that of Example 1, except that the adhesive coating of this Example was used. Moreover, the weight ratio of the thermosetting resin component (a)/the thermoplastic resin component (b) was 1.50.

| | |
|---|---|
| The thermosetting resin component (a): | |
| Phenol resin | 60 parts by weight |
| The thermoplastic resin component (b) | |
| Dimer acid-based polyamide | 40 parts by weight |
| (weight average molecular weight: 12,000) | |

### Example 3

The adhesive coating having the following composition of this Example was prepared.

Then, the adhesive sheet of this Example was prepared in a manner identical to that of Example 1, except that the adhesive coating of this Example was used. Moreover, the weight ratio of the thermosetting resin component (a)/ the thermoplastic resin component (b) was 1.43.

| | |
|---|---|
| The thermosetting resin component (a): | |
| Maleimide resin (marketed by K-I Chemical | 57 parts by weight |
| Industry Co., Ltd.; and trade name: BMI-80) | |
| The thermoplastic resin component (b) | |
| Dimer acid-based polyamide | 40 parts by weight |
| (weight average molecular weight: 12,000) | |
| Other component | |
| Organic peroxides (marketed by NOF | 3 parts by weight |
| CORPORATION; trade name: Perbutyl P) | |

### Example 4

The adhesive coating having the following composition of this Example was prepared.

Next, as the heat resistant base, a copper foil (¾ ounce; marketed by MITSUI MINING & SMELTING Co., Ltd.; trade name: 3EC-VLP; thickness: 25 μm) was used. On a rough surface of the copper foil, the obtained adhesive coating was coated such that the thickness after drying was 8 μm, and this was dried at 100° C. for 5 minutes, and thereby the adhesive sheet of this Example was obtained. Moreover, the weight ratio of the thermosetting resin component (a)/the thermoplastic resin component (b) is 1.48.

| | | |
|---|---|---|
| The thermosetting resin component (a): | | |
| Epoxy resin (marketed by Japan Epoxy Resins Co., | 30 | parts by weight |
| Ltd., trade name: YX-4000H; | | |
| epoxy equivalent: 190) | | |
| Phenol resin (marketed by SHOWA | 29 | parts by weight |
| HIGHPOLYMER; trade name: CKM-2400) | | |
| The thermoplastic resin component (b) | | |
| Dimer acid-based polyamide (weight average | 40 | parts by weight |
| molecular weight: 12,000) | | |
| Other component | | |
| Hardening accelerator (marketed by Shikoku Corp.; | 1 | part by weight |
| 2-ethyl-4-methylimidazole) | | |

### Comparative Example 1

The adhesive coating having the following composition of this Comparative Example was prepared.

Then, the adhesive sheet of this Comparative Example was prepared in a manner identical to that of Example 1, except that the adhesive coating of this Comparative Example was used. Moreover, the weight ratio of the thermosetting resin component (a)/the thermoplastic resin component (b) was 3.90.

| | | |
|---|---|---|
| The thermosetting resin component (a): | | |
| Epoxy resin (marketed by Japan Epoxy | 39 | parts by weight |
| Resins Co., Ltd; trade name: YX-4000H; | | |
| epoxy equivalent: 190) | | |
| Phenol resin (marketed by SHOWA | 39 | parts by weight |
| HIGHPOLYMER; trade name: CKM-2400) | | |
| The thermoplastic resin component (b) | | |
| Dimer acid-based polyamide | 20 | parts by weight |
| (weight average molecular weight: 12,000) | | |
| Other component | | |
| Hardening accelerator (marketed by Shikoku Corp.; | 1 | part by weight |
| 2-ethyl-4-methylimidazole) | | |

### Comparative Example 2

The adhesive coating having the following composition of this Comparative Example was prepared.

Then, the adhesive sheet of this Comparative Example was prepared in a manner identical to that of Example 1, except that the adhesive coating of this Comparative Example was used. Moreover, the weight ratio of the thermosetting resin component (a)/the thermoplastic resin component (b) was 0.24.

| | | |
|---|---|---|
| The thermosetting resin component (a): | | |
| Epoxy resin (marketed by Japan Epoxy | 10 | parts by weight |
| Resins Co., Ltd.; trade name: YX-4000H; | | |
| epoxy equivalent: 190) | | |
| Phenol resin (marketed by SHOWA | 9 | parts by weight |
| HIGHPOLYMER; trade name: CKM-2400) | | |
| The thermoplastic resin component (b) | | |
| Dimer acid-based polyamide | 80 | parts by weight |
| (weight average molecular weight: 12,000) | | |
| Other component | | |
| Hardening accelerator (marketed by Shikoku Corp.; | 1 | part by weight |
| 2-ethyl-4-methylimidazole) | | |

### Comparative Example 3

As the heat resistant base, a polyimide resin film (marketed by Du Pont-Toray Co., Ltd.; trade name: KAPTON® 100EN; thickness. 25 μm; glass transition temperature: 300° C. or greater, coefficient of thermal expansion: 16 ppm/° C.) was used. On the polyimide resin film, the adhesive coating containing only the thermoplastic resin component (b), acrylonitrile-butadiene copolymer was applied such that the thickness after drying was 6 μm, and this was dried at 100° C. for 5 minutes, and thereby the adhesive sheet of this Comparative Example was obtained.

### Comparative Example 4

Polyalkylaralkylsiloxane (marketed by GE Toshiba Silicones; trade name: TSR-1512; weight average molecular weight: 500,000, solid content concentration: 60 parts) and polyalkyl hydrogenated siloxane (marketed by GE Toshiba Silicones; trade name: CR-51; weight average molecular weight: 1,300) were mixed at a weight ratio of 100-1, and thereby a silicone base adhesive coating containing only the thermoplastic resin component (b) was obtained.

Next, as the heat resistant base, a polyimide resin film (marketed by Du Pont-Toray Co, Ltd.; trade name: KAPTON® 100EN; thickness: 25 μm; glass transition temperature: 300° C. or greater; coefficient of thermal expansion: 16 ppm/° C.) was used. On the polyimide resin film, the obtained adhesive coating containing only the thermoplastic resin component (b) was applied such that the thickness after drying was 6 μm, this was dried at 100° C. for 5 minutes, and thereby the adhesive sheet of this Comparative Example was obtained.

### Example 5

The mixture having the following composition and tetrahydrofuran were mixed and the adhesive coating of this Example was prepared.

Next, as the heat resistant base, a polyimide resin film (marketed by Du Pont-Toray Co., Ltd.; trade name: KAPTON® 100EN; thickness: 25 μm; glass transition temperature: 300° C. or greater; coefficient of thermal expansion: 16 ppm/° C.) was used. On the polyimide resin film, the obtained adhesive coating was applied such that the thickness after drying was 6 μm, and this was dried at 100° C. for 5 minutes, and thereby the adhesive sheet of this Example was obtained. Moreover, the weight ratio of the thermosetting resin component (a)/butadiene containing resin (b) was 1.50.

| | | |
|---|---|---|
| The thermosetting resin component (a): | | |
| Epoxy resin (marketed by DAINIPPON | 40 | parts by weight |
| INK AND CHEMICALS, INCORPORATED; | | |
| trade name: HP-7200) | | |
| Phenol resin (marketed by NIPPON | 20 | parts by weight |
| KAYAKU CO., LTD.; trade name: TPM) | | |
| Butadiene containing resin (b) | | |
| Acrylonitrile-butadiene-methacrylate copolymer | 40 | parts by weight |
| (marketed by JSR Corporation; | | |
| trade name: PNR-1H; weight average | | |
| molecular weight: 330,000) | | |
| Other component | | |
| Hardening accelerator (marketed by Shikoku Corp; | 1 | part by weight |
| 2-ethyl-4-methylimidazole) | | |

### Example 6

The mixture having the following composition and tetrahydrofuran were mixed and the adhesive coating of this Example was prepared.

Then, the adhesive sheet of this Example was prepared in a manner identical to that of Example 5, except that the adhesive coating of this Example was used. Moreover, the weight ratio of the thermosetting resin component (a)/butadiene containing resin (b) was 1.45.

| | |
|---|---|
| The thermosetting resin component (a): | |
| Maleimide resin (marketed by K-I Chemical | 58 parts by weight |
| Industry Co., Ltd.; trade name: | |
| BMI-80) | |
| Butadiene containing resin (b) | |
| styrene epoxide-butadiene-styrene copolymers | 40 parts by weight |
| (marketed by DAICEL CHEMICAL | |
| INDUSTRIES, LTD.; trade name: | |
| EPOFRIEND ® A 1020; weight average | |
| molecular weight: 50,000) | |
| Other component | |
| Organic peroxides (marketed by NOF | 2 parts by weight |
| CORPORATION; trade name: Perbutyl P) | |

### Example 7

The mixture having the following composition and tetrahydrofuran were mixed and the adhesive coating of this Example was prepared.

Then, the adhesive sheet of this Example was prepared in a manner identical to that of Example 5, except that the adhesive coating of this Example was used. Moreover, the weight ratio of the thermosetting resin component (a)/butadiene containing resin (b) was 1.50.

| | | |
|---|---|---|
| The thermosetting resin component (a): | | |
| Epoxy resin (marketed by DAINIPPON INK | 40 | parts by weight |
| AND CHEMICALS, INCORPORATED; | | |
| trade name: HP-7200) | | |
| Phenol resin (marketed by NIPPON | 20 | parts by weight |
| KAYAKU CO., LTD.; trade name: TPM) | | |
| Butadiene containing resin (b) | | |
| Polybutadiene epoxides (marketed by DAICEL | 40 | parts by weight |
| CHEMICAL INDUSTRIES, LTD.; | | |
| trade name: EPOLEAD ® PB3600, | | |
| weight average molecular weight: 20,000) | | |
| Other component | | |
| Hardening arcelerator (marketed by Shikoku Corp.; | 1 | part by weight |
| 2-ethyl-4-methylimidazole) | | |

### Example 8

The mixture having the following composition and tetrahydrofuran were mixed and the adhesive coating of this Example was prepared.

Then, the adhesive sheet of this Example was prepared in a manner identical to that of Example 5, except that the adhesive coating of this Example was used. Moreover, the weight ratio of the thermosetting resin component (a)/butadiene containing resin (b) was 1.50.

| | |
|---|---|
| The thermosetting resin component (a): | |
| Phenol resin (marketed by SHOWA | 60 parts by weight |
| HIGHPOLYMER; trade name: CKM-908) | |
| Butadiene containing resin (b) | |
| Acrylonitrile-butadiene copolymers | 40 parts by weight |
| (marketed by ZEON CORPORATION; trade name: | |
| NIPOL ® 1001; weight average | |
| molecular weight: 30,000) | |

### Example 9

The mixture having the following composition and tetrahydrofuran were mixed and the adhesive coating of this Example was prepared.

Next, as the heat resistant base, a copper foil (¾ ounce; marketed by MITSUI MINING & SMELTING Co., Ltd.; trade name: 3EC-VLP; thickness: 25 μm) was used. On a rough surface of the copper foil, the obtained adhesive coating was applied such that the thickness after drying was 8 μm, and this was dried at 100° C. for 5 minutes, and thereby the adhesive sheet of this Example was obtained. Moreover, the weight ratio of the thermosetting resin component (a)/butadiene containing resin (b) was 1.50.

| | | |
|---|---|---|
| The thermosetting resin component (a): | | |
| Epoxy resin (marketed by | 40 | parts by weight |
| DAINIPPON INK AND CHEMICALS, | | |
| INCORPORATED; trade name: HP-7200) | | |
| Phenol resin (marketed by NIPPON KAYAKU CO., | 20 | parts by weight |
| LTD.; trade name: TPM) | | |
| Butadiene containing resin (b) | | |
| Acrylonitrile-butadiene-methacrylate copolymer | 40 | parts by weight |
| (marketed by JSR Corporation; trade name: | | |
| PNR-1H; weight average molecular | | |
| weight: 330,000) | | |
| Other component | | |
| Hardening accelerator (marketed by Shikoku Corp.; | 1 | part by weight |
| 2-ethyl-4-methylimidazole) | | |

### Comparative Example 5

The mixture having the following composition and tetrahydrofuran were mixed and the adhesive coating of this Comparative Example was prepared.

Then, the adhesive sheet of this Comparative Example was prepared in a manner identical to that of Example 5, except that the adhesive coating of this Comparative Example was used. Moreover, the weight ratio of the thermosetting resin component (a)/butadiene containing resin (b) was 4.00.

| | | |
|---|---|---|
| The thermosetting resin component (a): | | |
| Epoxy resin (marketed by DAINIPPON INK | 55 | parts by weight |
| AND CHEMICALS, INCORPORATED; | | |
| trade name: HP-7200) | | |
| Phenol resin (marketed by NIPPON KAYAKU | 25 | parts by weight |
| CO, LTD.; trade name: TPM) | | |
| Butadiene containing resin (b) | | |
| Acrylonitrile-butadiene-methacrylate copolymer | 20 | parts by weight |
| (marketed by JSR Corporation; | | |
| trade name: PNR-1H; weight average | | |
| molecular weight: 330,000) | | |
| Other component | | |
| Hardening accelerator (marketed by Shikoku Corp; | 1 | part by weight |
| 2-ethyl-4-methylimidazole) | | |

### Comparative Example 6

The mixture having the following composition and tetrahydrofuran were mixed and the adhesive coating of this Comparative Example was prepared.

Then, the adhesive sheet of this Comparative Example was prepared in a manner identical to that of Example 5, except that the adhesive coating of this Comparative Example was used. Moreover, the weight ratio of the thermosetting resin component (a)/butadiene containing resin (b) was 0.25.

| | | |
|---|---|---|
| The thermosetting resin component (a): | | |
| Epoxy resin (marketed by DAINIPPON | 15 | parts by weight |
| INK AND CHEMICALS, INCORPORATED; | | |
| trade name: HP-7200) | | |
| Phenol resin (marketed by NIPPON KAYAKU CO., | 5 | parts by weight |
| LTD.; trade name TPM) | | |
| Butadiene containing resin (b) | | |
| Acrylonitrile-butadiene-methacrylate copolymer | 80 | parts by weight |
| (marketed by JSR Corporation; | | |
| trade name: PNR-1H; weight average | | |
| molecular weight: 330,000) | | |
| Other component | | |
| Hardening accelerator (marketed by Shikoku Corp.; | 1 | part by weight |
| 2-ethyl-4-methylimidazole) | | |

### Comparative Example 7

Silicone adhesive (marketed by Shin-Etsu Chemical Co; trade name: X40-3103; weight average molecular weight: 20,000; solid content concentration: 60 parts) and platinum catalyst (marketed by Shin-Etsu Chemical Co; trade name: PL-50T) were mixed at a weight ratio of 100:1, and thereby a silicone base adhesive coating was obtained.

Next, as the heat resistant base, a polyimide resin film (marketed by Du Pont-Toray Co., Ltd.; trade name: KAPTON® 100EN; thickness: 25 μm; glass transition temperature: 300° C. or greater; coefficient of thermal expansion: 16 ppm/° C.) was used. On the polyimide resin film, the obtained silicone base adhesive coating was applied such that the thickness after drying was 6 μm, this was dried at 100° C. for 5 minutes, and thereby the adhesive sheet of this Comparative Example was obtained.

### Comparative Example 8

14 parts by weight of epoxy resin (marketed by DAINIPPON INK AND CHEMICALS, INCORPORATED; trade name: HP-7200), 7 parts by weight of phenol resin (marketed by NIPPON KAYAKU CO., LTD.; trade name: TPM), 79 parts by weight of acrylate-glycidyl acrylate-acrylonitrile copolymers (marketed by Nagase ChemteX Corporation; trade name: SG P-3DR; weight average molecular weight: 1,000,000), and 1 part by weight of hardening accelerator (marketed by Shikoku Corp.; 2-ethyl-4-methylimidazole) were mixed in tetrahydrofuran, and thereby the adhesive coating of this Comparative Example was obtained. Moreover, the weight ratio of the thermosetting resin component (a)/butadiene containing resin (b) was 0.27.

Next, as the heat resistant base, a polyimide resin film (marketed by Du Pont-Toray Co., Ltd.; trade name: KAPTON® 100EN; thickness: 25 μm; glass transition temperature: 300° C. or greater; coefficient of thermal expansion: 16 ppm/° C.) was used. On the polyimide resin film, the obtained silicone base adhesive coating was coated such that the thickness after drying was 6 μm, this was dried at 100° C. for 5 minutes, and thereby the adhesive sheet of this Comparative Example was obtained.

Evaluation of the Adhesive Layer

Measurement Method for Storage Elastic Modulus

The release film with the adhesive layer was obtained by applying the adhesive coating obtained in the Examples and Comparative Examples on the release film and drying the adhesive coating under the same conditions in the producing process for the adhesive sheet (applying the adhesive coating such that the thickness after drying was 0.1 mm and this was dried at 100° C. for 5 minutes), and this was heated under the same conditions (at 175° C. for 2 hours) in the die attaching step. Then, after applying the adhesive such that the thickness after drying was 0.1 mm, this was dried. The obtained sample was cut, and test pieces having a size of 5 mm×30 mm were obtained.

Using elastic modulus measuring machine (marketed by Orientec Co., Ltd.; trade name: RHEOVIBRON DDV-II), the storage elastic modulus of the adhesive layer in the Examples 1 to 4 and the Comparative Examples 1 to 3 was measured under conditions in which the frequency was 11 Hz, the rate of temperature increase was 3° C./min., and the measurement temperature range was 150 to 300° C. The storage elastic modulus in the following Table 1 is the smallest storage elastic modulus in the measurement temperature range of 150 to 300° C.

In the adhesive coating in the Comparative Example 4, the storage elastic modulus could not be measured by the above elastic modulus measuring machine. Therefore, the adhesive coating obtained in the Comparative Example 4 was applied such that the thickness of the adhesive layer after drying was 1 mm, and this was dried. Then, the obtained samples were cut and disc-shaped test pieces having a diameter of 7 mm were obtained. Using the obtained disc-shaped test piece and elastic modulus measuring machine (marketed by Haake, trade name: Reostress), the storage elastic modulus of the adhesive layer was measured under conditions in which the frequency was 1 Hz, the rate of temperature increase was 3° C./min., the measurement temperature range was 150 to 300° C., and the load was 10 N.

Moreover, in the adhesive coatings in the Examples 5 to 9 and the Comparative Examples 5 to 8, using the elastic modulus measuring machine (marketed by Orientec Co., Ltd., trade name: RHEOVIBRON DDV-II), the storage elastic modulus of the adhesive layer was measured under conditions in which the frequency was 11 Hz, the rate of temperature increase was 3° C./min., and the measurement temperature range was 150 to 250° C. The storage elastic modulus in the following Table 1 is the smallest storage elastic modulus in the measurement temperature range of 150 to 250° C.

Evaluation of the Adhesive Sheets

1. Detection Method for Wire-Bonding Defect

The obtained adhesive sheet in the Examples and Comparative Examples was attached on a lead frame for QFNs (total size: 200 mm×60 mm; copper lead frame platted with Au—Pd—Ni; 4×16 (64) QFNs; package size; 10×10 mm; 84 pins) by a lamination method. After mounting dummy chips (in the Examples 1 to 4 and Comparative Examples 1 to 4, dummy chips having dimensions of 3 mm×3 mm×0.4 mm thick were used; in the Examples 5 to 9 and Comparative Examples 5 to 8, the dummy chips having dimensions of 6 mm×6 mm×0.4 mm thick were used) on the semiconductor element mount parts of the lead frame, using a wire bonder (marketed by KAIJO Corporation; trade name: FB-131), the dummy chips and leads were electrically connected with gold wires under conditions in which the heat temperature was 210° C., the frequency was 100 k Hz, the lead was 150 gF, and the operation time was 10 msec/pin. The obtained 64 packages were examined, and the number of packages, in which a connection defect occurs in the leads, is denoted by the number of wire-bonding defects. The results are shown in the following Table 1.

2. Detection Method for Mold flash

Using the lead frame after evaluation of wire-bonding defect, the mold flash was detected. The dummy chips were filled with a filler resin (biphenylepoxy based mold agent; filler amount: 85% by weight) in a manner of a transfer-mold method under conditions in which heating temperature was 180° C., pressure was 10M Pa, and operation time was 3 minutes. The packages after the resin filling step were examined, and number of packages, in which the filler resin attaches at external connection parts of the lead (the surface of the lead at which the adhesive sheet is attached), is denoted by a number of mold flashes. The results are shown in Table 1 below.

3. Measurement Method for Adhesive Strength

The adhesive sheets obtained in the Examples and Comparative Examples were cut such that the widths thereof were 1 cm, and these were attached on a copper plate having dimensions of 50 mm×100 mm×0.25 mm thick (marketed by MITSUBISHI METECS; trade name: MF-202) and the copper plate plated with gold by a roll-lamination method. The plate was heated to 150° C., and then the peel strength was measured when the adhesive layer of the obtained laminate was peeled from the plate such that the peeled adhesive layer forms an angle of 90° with respect to the plate. While the heated temperature changes from 150 to 250° C., this measurement was carried out at every 5° C. in temperature rise. Moreover, the adhesive strength in the following Table 1 is the smallest peel strength in the heated temperature range. Moreover, the adhesive sheet was attached on the copper plate or the copper plate plated with gold such that the adhesive strength therebetween was 10 g/cm or greater, which was required in practical use.

4. Detection Method for Adhesive Transfer

Similarly in the detection of mold flash, after the dummy chips are filled with the mold agent, the adhesive sheet was peeled from the lead frame with a peel speed of 500 mm/min. Then, after peeling the adhesive sheet, the 64 packages were examined, and the number of packages, in which the adhesive was transferred to the external connection parts of the lead (the surface of the lead at which the adhesive sheet was attached), is denoted by the number of adhesive transfers. The results are shown in the following Table 1.

TABLE 1

| | Storage | | | Adhesive Strength to | | Number |
|---|---|---|---|---|---|---|
| | Elastic | Number of | Number of | Copper plate (g/cm) | | of |
| | Modulus | Wire-bonding | Mold | Non-gold | Gold | Adhesive |
| | (MPa) | defects | flashes | plating | plating | transfers |
| Example 1 | 80 | 0 | 0 | 33 | 20 | 0 |
| Example 2 | 100 | 0 | 0 | 39 | 29 | 0 |
| Example 3 | 120 | 0 | 0 | 25 | 13 | 0 |
| Example 4 | 80 | 0 | 0 | 36 | 23 | 0 |
| Comparative | 110 | 0 | 3 | 19 | 12 | 53 |
| Example 1 | | | | | | |
| Comparative | 3 | 49 | 0 | 48 | 35 | 0 |
| Example 2 | | | | | | |
| Comparative | 0.001 | 60 | 49 | 9 | 6 | 55 |
| Example 3 | | | | | | |
| Comparative | 0.01 | 38 | 4 | 30 | 21 | 0 |
| Example 4 | | | | | | |
| Example 5 | 8 | 0 | 0 | 20 | 15 | 0 |
| Example 6 | 50 | 0 | 0 | 16 | 32 | 0 |
| Example 7 | 10 | 0 | 0 | 25 | 20 | 0 |
| Example 8 | 80 | 0 | 0 | 33 | 24 | 0 |
| Example 9 | 8 | 0 | 0 | 20 | 15 | 0 |
| Comparative | 15 | 0 | 5 | 8 | 5 | 25 |
| Example 5 | | | | | | |
| Comparative | 1 | 18 | 0 | 42 | 36 | 0 |
| Example 6 | | | | | | |
| Comparative | 0.05 | 36 | 0 | 22 | 14 | 5 |
| Example 7 | | | | | | |
| Comparative | 0.001 | 25 | 11 | 35 | 21 | 11 |
| Example 8 | | | | | | |

As shown in Table 1, in the adhesive sheet of the Examples, wire-bonding defects, mold flashes, and adhesive transfers do not occur. In contrast, in the adhesive sheets comprising the adhesive layer in which the thermosetting resin component (a)/the thermoplastic resin component (b) exceeds 3 obtained in the Comparative Examples 1 and 5, mold flashes were generated and the number of adhesive transfers was large. In the adhesive sheets comprising the adhesive layer in which the thermosetting resin component (a)/the thermoplastic resin component (b) less than 0.4 obtained in the Comparative Example 2, and adhesive sheets comprising the adhesive layer in which this is less than 0.3 obtained in the Comparative Example 6, the number of wire-bonding defects was large. In the adhesive sheet comprising the adhesive layer containing no thermosetting resin component (a), wire-bonding defects and mold flashes were generated. In particular, the adhesive sheet obtained in the Comparative Example 3 has inferior adhesive strength, which shows this is not suitable for practical use. In the adhesive sheet obtained in the Comparative Example 7, which does not contain both of the thermosetting resin component (a) and the thermoplastic resin component (b), wire-bonding defects were generated. In the adhesive sheet obtained in the Comparative Example 8, wire-bonding defects, mold flashes, and adhesive transfers were confirmed

What is claimed is:

1. An adhesive sheet for producing semiconductor devices which is detachably attached to a lead frame and which comprises a heat resistant substrate and an adhesive layer which is arranged on one surface of the heat resistant substrate,
wherein the adhesive layer contains a thermosetting resin component (a) and a thermoplastic resin component (b); and the weight ratio of the component (a)/the component (b) is 0.3 to 3.

2. An adhesive sheet according to claim 1, wherein the heat resistant substrate is a heat resistant film, and the glass transition temperature and the coefficient of thermal expansion of the heat resistant film are 150° C. or greater and 5 to 50 ppm/° C.

3. An adhesive sheet according to claim 1, wherein the heat resistant substrate is a metal foil and the coefficient of thermal expansion of the metal foil is 5 to 50 ppm/° C.

4. An adhesive sheet according to claim 3, wherein the metal foil is an electrolytic metal foil having a rough surface and the adhesive layer is attached on the rough surface of the electrolytic metal foil.

5. An adhesive sheet according to claim 1, wherein the thermosetting resin component (a) is at least one resin of epoxy resins and phenol resins.

6. An adhesive sheet according to claim 1, wherein the thermoplastic resin component (b) is a polymer having an amide bond.

7. An adhesive sheet according to claim 1, wherein the thermoplastic resin component (b) is a butadiene containing resin.

8. An adhesive sheet according to claim 1, wherein the weight average molecular weight of the thermoplastic resin component (b) is 2,000 to 1,000,000.

9. An adhesive sheet according to claim 1, wherein the storage elastic modulus at 150 to 250° C. after hardening of the adhesive layer is 5 MPa or more.

10. An adhesive sheet according to claim 1, wherein a protective film is arranged on the adhesive layer.
